(19) United States
(12) Patent Application Publication
(10) Pub. No.: US 2025/0139524 A1
(43) Pub. Date: May 1, 2025

(54) METHOD FOR CREATING COLOR PREDICTION MODEL, COLOR PREDICTION MODEL CREATION APPARATUS, PRINTING SYSTEM, AND NON-TRANSITORY COMPUTER-READABLE STORAGE MEDIUM

(71) Applicant: SEIKO EPSON CORPORATION, TOKYO (JP)

(72) Inventors: Yasuhiro TAKEUCHI, AZUMINO-SHI (JP); Takahiro KAMADA, MATSUMOTO-SHI (JP); Yuko YAMAMOTO, SHIOJIRI-SHI (JP); Mitsuhiro YAMASHITA, MATSUMOTO-SHI (JP)

(21) Appl. No.: 18/926,364

(22) Filed: Oct. 25, 2024

(30) Foreign Application Priority Data
Oct. 25, 2023 (JP) 2023-183104

(51) Int. Cl. G06N 20/00; B41J 2/21; G06T 7/90; H04N 1/60

(52) U.S. Cl. CPC G06N 20/00; G06T 7/90; H04N 1/6033; B41J 2/21; G06T 2207/10024; G06T 2207/20081

(57) ABSTRACT

A method of creating a color prediction model includes (a) acquiring color chart data representing N color patch groups; (b) a process of executing an accuracy calculation process sequentially while increasing an integer n, the process including (i) creating n tentative training datasets corresponding to n color patch groups using a predicted spectral reflectance predicted by a simple color prediction model, (ii) creating the tentative color prediction model by training the color prediction model with n tentative training datasets, and (iii) calculating a prediction accuracy of the tentative color prediction model; (c) a process of determining a number n_{c} of color patch groups suitable for training the color prediction model using a relationship between the integer n and the prediction accuracy; (d) executing printing and measurement of spectral reflectances for the n_{c} color patch groups, and creating training data including measurement results of the spectral reflectances; and (e) performing training of the color prediction model.

The present application is based on, and claims priority from JP Application Serial Number 2023-183104, filed Oct. 25, 2023, the disclosure of which is hereby incorporated by reference herein in its entirety.

### BACKGROUND

### 1. Technical Field

The present disclosure relates to a method for creating a color prediction model, a color prediction model creation apparatus, a printing system, and a computer program.

### 2. Related Art

In a printing device, color conversion processing is performed to convert the color value of input image data expressed by a first color system into the color value of a second color system corresponding to the type of ink. In the color conversion processing, a plurality of color conversion tables that associate the color value of the first color system with the color value of the second color system are referred to. When such a color conversion table is created, a color prediction model for predicting, from an arbitrary ink amount set, the spectral reflectance of a printed matter printed with the ink amount set is used. JP-A-2023-128280 disclosed by the applicant of the present disclosure discloses a method of creating a teacher dataset of a color prediction model while repeating selection and training from a virtual teacher dataset candidate group created using a pre-model. According to this method, the prediction accuracy of the color prediction model can be efficiently improved by additionally selecting the teaching data of the color prediction model.

In recent years, it is difficult to say that it is always desired to create a color prediction model with the highest accuracy by taking a long work time, and there are cases where it is desired to create a color prediction model in a short work time even if the prediction accuracy is somewhat inferior. In addition, with the widespread use of color prediction models, it has been required to achieve a balance between prediction accuracy and work time in accordance with applications.

### SUMMARY

According to a first aspect of the present disclosure, there is provided a method of creating a color prediction model for predicting a spectral reflectance from an ink amount set of a plurality of types of inks constituting an ink set. The method includes (a) acquiring color chart data representing N color patch groups, N being an integer of 2 or more; (b) executing an accuracy calculation process sequentially while increasing an integer n, which is an integer of one to N, the accuracy calculation process including (i) creating n tentative training datasets corresponding to n color patch groups using a predicted spectral reflectance predicted by a simple color prediction model that is more easily trainable than is the color prediction model, (ii) creating the tentative color prediction model by training the color prediction model with n tentative training datasets, and (iii) calculating a prediction accuracy of the tentative color prediction model; (c) determining a number n_{c} of color patch groups suitable for training the color prediction model using a relationship between the integer n and the prediction accuracy; (d) executing printing by a printing device and measurement of spectral reflectances for the n_{c} color patch groups, and creating training data including measurement results of the spectral reflectances; and (e) performing training of the color prediction model using the training data.

According to a second aspect of the present disclosure, there is provided a color prediction model creation apparatus that creates a color prediction model for predicting spectral reflectance from an ink amount set of a plurality of types of inks constituting an ink set. The color prediction model creation apparatus includes a data acquisition section configured to obtain color chart data representing N color patch groups, N being an integer of 2 or more; calculation section that executes an accuracy an accuracy calculation process sequentially while increasing an integer n, which is an integer of 1 to N, the accuracy calculation process including (i) creating n sets of tentative training datasets corresponding to n groups of color patches using predicted spectral reflectance predicted by a simple color prediction model that is more easily trainable than is the color prediction model, (ii) creating a tentative color prediction model by performing training of the color prediction model using the n tentative training datasets, and (iii) calculating a prediction accuracy of the tentative color prediction model; a determination section configured to determine a number n_{c} of color patch groups suitable for training the color prediction model using a relationship between the integer n and the prediction accuracy; a training data creation section, for the color patch groups of the number n_{c}, that executes printing by a printing device, that measurement of spectral reflectance, and creates training data including a measurement result of the spectral reflectance; and a training section configured to execute training of the color prediction model using the training data.

According to a third aspect of the present disclosure, a printing system is provided. The printing system includes a color prediction model creation apparatus that creates a color prediction model for predicting spectral reflectance using an ink amount set of a plurality of types of inks constituting an ink set and a printing device. The color prediction model creation apparatus includes a data acquisition section configured to obtain color chart data representing N color patch groups, N being an integer of 2 or more; an accuracy calculation section that executes an accuracy calculation process sequentially while increasing an integer n, which is an integer of 1 to N, the accuracy calculation process including (i) creating n sets of tentative training datasets corresponding to n groups of color patches using predicted spectral reflectance predicted by a simple color prediction model that is more easily trainable than is the color prediction model, (ii) creating a tentative color prediction model by performing training of the color prediction model using the n tentative training datasets, and (iii) calculating a prediction accuracy of the tentative color prediction model; a determination section configured to determine a number n_{c} of color patch groups suitable for training the color prediction model using a relationship between the integer n and the prediction accuracy; a training data creation section, for the color patch groups of the number n_{c}, that executes printing by the printing device and that measurement of spectral reflectance, and creates training data including a measurement result of the spectral reflectance, and a training section configured to execute training of the color prediction model using the training data.

According to a fourth aspect of the present disclosure, there is provided a computer program for creating a color prediction model for predicting a spectral reflectance from an ink amount set of a plurality of types of inks constituting an ink set. The computer program is executed by a computer, the processes comprising: (a) a process of acquiring color chart data representing N color patch groups, N being an integer of 2 or more; (b) a process of executing an accuracy calculation process sequentially while increasing an integer n, which is an integer of one to N, the process including (i) creating n tentative training datasets corresponding to n color patch groups using a predicted spectral reflectance predicted by a simple color prediction model that is more easily trainable than is the color prediction model, (ii) creating the tentative color prediction model by training the color prediction model with n tentative training datasets, and (iii) calculating a prediction accuracy of the tentative color prediction model; (c) a process of determining a number n_{c} of color patch groups suitable for training the color prediction model using a relationship between the integer n and the prediction accuracy; (d) a process of executing printing by a printing device and measurement of spectral reflectances for the n_{c} color patch groups, and creating training data including measurement results of the spectral reflectances, and (e) a process of performing training of the color prediction model using the training data.

### BRIEF DESCRIPTION OF THE DRAWINGS

FIG. 1 is a block diagram of a printing system.

FIG. 2 is an explanatory diagram illustrating an example of color chart information.

FIG. 3 is a flowchart illustrating a procedure of a color prediction model creation process according to the first embodiment.

FIG. 4 is an explanatory diagram showing an example of a print setting window.

FIG. 5 is an explanatory diagram showing an example of a window for colorimetry setting.

FIG. 6 is an explanatory diagram showing an example of a window for selecting color chart data.

FIG. 7 is an explanatory diagram showing a relationship between the number of color charts and prediction accuracy in the first embodiment.

FIG. 8 is an explanatory diagram illustrating an example of changing the number of times of training of a tentative color prediction model according to the number of color charts.

FIG. 9 is an explanatory diagram illustrating an example of changing the number of times of training of a tentative color prediction model according to prediction accuracy.

FIG. 10 is an explanatory diagram illustrating an example of a printing device including a colorimeter.

FIG. 11 is a flowchart illustrating a procedure of a color prediction model creation process according to the second embodiment.

FIG. 12 is an explanatory view showing an example of a window for designating the number of color charts in the second embodiment.

FIG. 13 is a flowchart illustrating a procedure of a color prediction model creation process according to the third embodiment.

### DESCRIPTION OF EMBODIMENTS

### A. First Embodiment

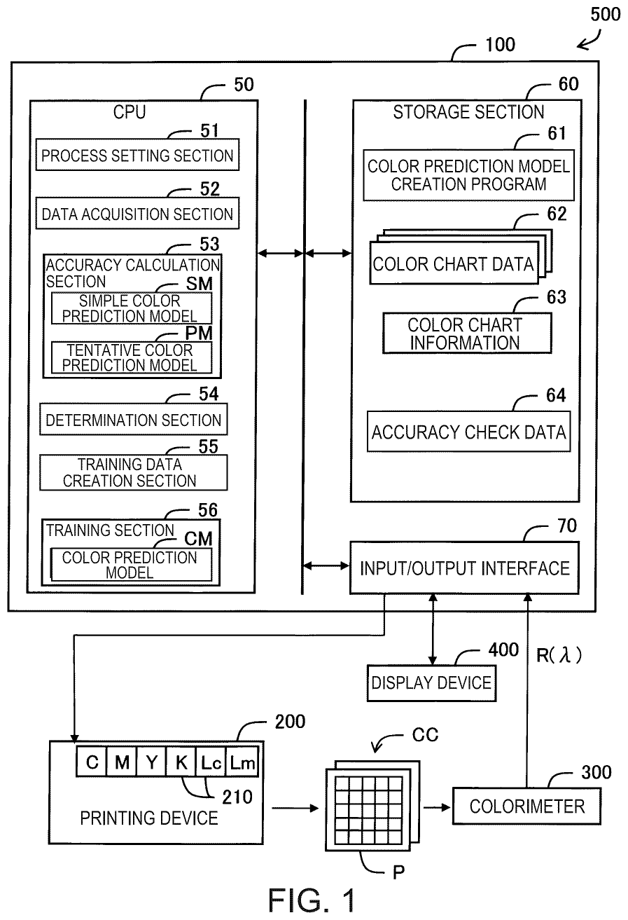

FIG. 1 is a block diagram illustrating a schematic configuration of a printing system according to an embodiment. The printing system 500 includes a color prediction model creation apparatus 100, a printing device 200, a colorimeter 300, and a display device 400.

The color prediction model creation apparatus 100 creates, from an ink amount set used in the printing device 200, a color prediction model CM for predicting the spectral reflectance of a printed material printed with the ink amount set. “Ink amount set” means a combination of ink amounts of a plurality of types of inks which can be used in the printing device 200. A combination of a plurality of types of inks that can be used in the printing device 200 is referred to as an “ink set”.

The color prediction model creation apparatus 100 is a computer including a CPU 50, a storage section 60, and an input/output interface 70. The CPU 50, the storage section 60, and the input/output interface 70 are coupled to each other via an internal bus so as to be able to communicate bi-directionally.

The CPU 50 functions as a process setting section 51, a data acquisition section 52, an accuracy calculation section 53, a determination section 54, a training data creation section 55, and a training section 56 by executing a color prediction model creation program 61 stored in advance in the storage section 60. At least a part of the functions of these sections 51 to 56 may be realized by a hardware circuit or may be realized in the cloud.

The process setting section 51 receives various process settings related to the creation process of the color prediction model CM. Details of the process setting will be described later.

The data acquisition section 52 acquires one or more set of color chart data 62 selected from plural sets of color chart data 62. One set of color chart data 62 is data representing N color patch groups, N being is an integer of 2 or more. In the present embodiment, it is assumed that one color patch group corresponds to one color chart CC. However, one color patch group may be defined by a unit different from one color chart CC. For example, a set of a predetermined number of color patches may be defined as the “color patch group”.

The accuracy calculation section 53 sequentially executes an accuracy calculation process, which includes the following processes (i) to (iii), while increasing an integer n, n being an integer of 1 to N.
(i) Predicted spectral reflectances that were predicted by a simple color prediction model SM, in which training can be performed more easily than in the color prediction model CM, are used to create n tentative training datasets corresponding to the n color patch groups.
(ii) The color prediction model CM is trained using the n sets tentative training datasets to create a tentative color prediction model PM.
(iii) The prediction accuracy of tentative color prediction model PM is calculated.

Details of the accuracy calculation process will be further described later.

“A simple color prediction model SM, in which training can be performed more easily than in the color prediction model CM” means that the amount of training data is smaller and the training time is shorter than those of the color prediction model CM. The simple color prediction model SM is a model for predicting a spectral reflectance from the ink-amount set, and can be configured as, for example, a color prediction model based on a known spectroscopic Neugebauer model. As a color prediction model based on the spectroscopic Neugebauer model, a printing model described in JP-A-2006-334945 can be used. Note that a color prediction model other than a spectroscopic Neugebauer model may be used as the simple color prediction model SM. However, it is preferable that the simple color prediction model SM has a smaller amount of training data necessary for training and a shorter training time than the color prediction model CM which is finally created. It is preferable that training of the simple color prediction model SM was completed using training data for the simple color prediction model SM created in advance.

The determination section 54 determines the number n_{c} of the color patch groups suitable for training of the color prediction model CM from the relationship between the integer n and the prediction accuracy. The number n_{c} is also referred to as an “optimum number n_{c}”. As described above, in the present embodiment, since one color patch group corresponds to one color chart CC, the number n_{c} of color patch groups corresponds to the number of color charts CC.

The training data creation section 55 executes printing by the printing device 200 and measurement of the spectral reflectances R(λ) by the colorimeter 300 for the n_{c} color patch groups, and creates training data including the measurement results of the spectral reflectances R(λ). The training data is data indicating the correspondence between the ink amount set and the spectral reflectances R(λ) for each color patch of the n_{c} color patch groups. The training section 56 executes training of the color prediction model CM using the training data.

The storage section 60 stores plural sets of color chart data 62, color chart information 63, and accuracy check data 64 in addition to the color prediction model creation program 61. The color chart data 62 is image data representing a color chart including a plurality of single-color patches and a plurality of mixed-color patches. The pixel value of the color chart data 62 is represented by an ink amount set. In the present embodiment, the plural sets of color chart data 62 are created in advance and stored in the storage section 60. The color chart information 63 is information related to the individual color chart data 62. The contents of the color chart information 63 will be described later.

The accuracy check data 64 is data used to calculate the prediction accuracy of the tentative color prediction model PM. The accuracy check data 64 is data indicating a correspondence relationship between ink amount sets and measured values of spectral reflectance for a plurality of ink amount sets. The spectral reflectance included in the accuracy check data 64 is preferably a measured value for a color patch printed on the same print medium as the print medium to which the color prediction model CM is applied.

The printing device 200 includes a plurality of ink containers 210, and one type of ink is contained in each ink container 210. In the present embodiment, the number of ink containers 210 is six, and an ink set including six types of ink of C, M, Y, K, Lc, Lm can be used. Here, C is cyan, M is magenta, Y is yellow, K is black, Lc is light cyan, and Lm is light magenta process ink. The printing device 200 may be configured to be able to use a special color ink. Not only the ink color type but also the number of ink colors can be arbitrarily set.

The input/output interface 70 transmits an image such as the color chart data 62 to the printing device 200 and receives a colorimetry result of a print image printed on the print medium P from the colorimeter 300. The input/output interface 70 further transmits a display image to the display device 400 to display various windows and processing results to be described later.

The printing device 200 is an inkjet printer that prints an image on the print medium P by ejecting ink onto the print medium P. When the printing device 200 receives the color chart data 62 from the color prediction model creation apparatus 100, the printing device 200 prints the color chart CC on the print medium P in response to the color chart data 62.

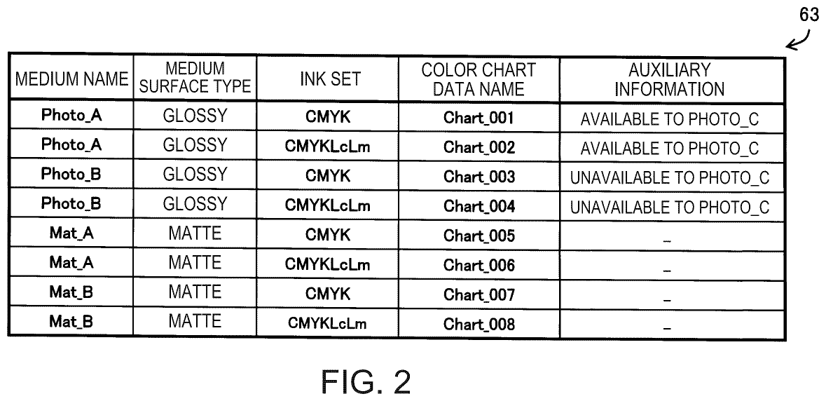

The colorimeter 300 performs colorimetry on printed matter created by the printing device 200. The colorimeter 300 measures each spectral reflectance R(λ) of a plurality of color patches included in the color chart CC. The measured spectral reflectances R(λ) are supplied to the color prediction model creation apparatus 100. FIG. 2 is an explanatory diagram showing an example of the color chart information 63. The color chart information 63 is information in which five items of (1) a medium name; (2) a surface type of a medium; (3) an ink set; (4) a color chart data name; and (5) auxiliary information are registered for each set of the color chart data 62.

In the present disclosure, “medium” means a print medium. In the example of FIG. 2, four medium names are presented: Photo_A, Photo_B, Mat_A, Mat_B. As described in the column of the front surface type of the medium, Photo_A and Photo_B are glossy paper, and Mat_A and Mat_B are matte paper. As the ink set, two types of ink sets of CMYK, and CMYKLcLm are proposed.

“Ink set CMYK” means any one of the following.
(a) An ink set for a printing device equipped with only CMYK inks.
(b) An ink set used in a print mode in which inks (Lc ink and Lm ink) other than CMYK among CMYKLcLm inks installed in the printing device are not used.

Usually, it is used in the meaning of the above (a), but may be used in the meaning of the above (b).

As auxiliary information, it is registered whether or not the color chart data for Photo_A and Photo_B can be used to create a color prediction model for Photo_C. For example, the color chart data for Photo_A can be used to create the color prediction model for Photo_C, but the color chart data for Photo_B cannot be used to create the color prediction model for Photo_C. Photo_C is a medium having color development characteristics close to Photo_A.

The reason for not preparing color chart data for Photo_C and registering the possibility of substituting other medium in the auxiliary information is that in practice it is difficult to prepare color chart data for all types of medium that are expected to be used. For this reason, in the present embodiment, it is assumed that color chart data is prepared for representative mediums, and this color chart data is diverted for mediums having similar characteristics.

A part of the five items illustrated in FIG. 2 can be omitted, and for example, the auxiliary information may be omitted.

In the first embodiment, one set of color chart data 62 is selected using the color chart information 63. However, color chart data to be referred to at the timing of print setting to be described later may be automatically selected without using the color chart information 63.

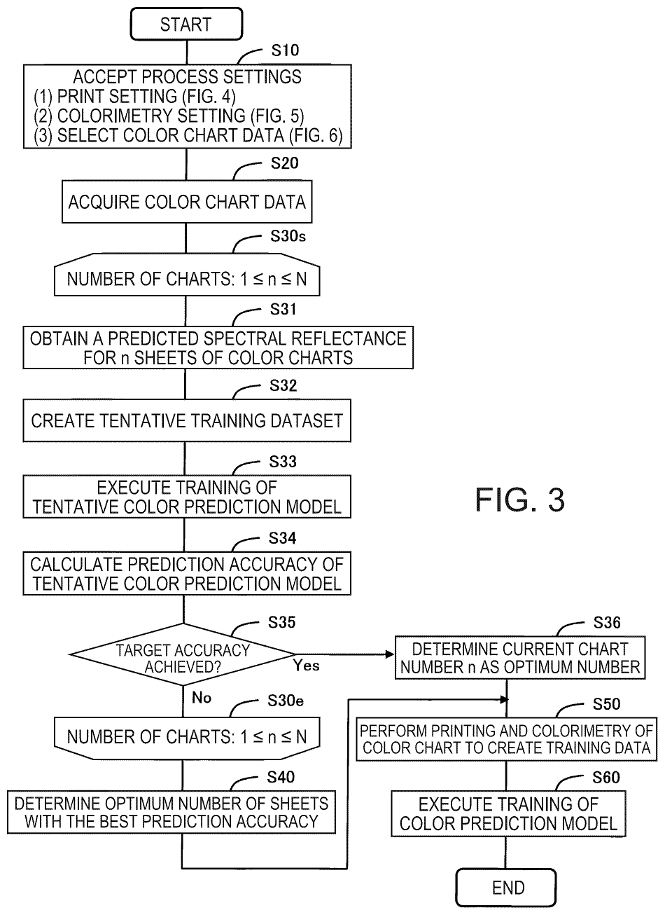

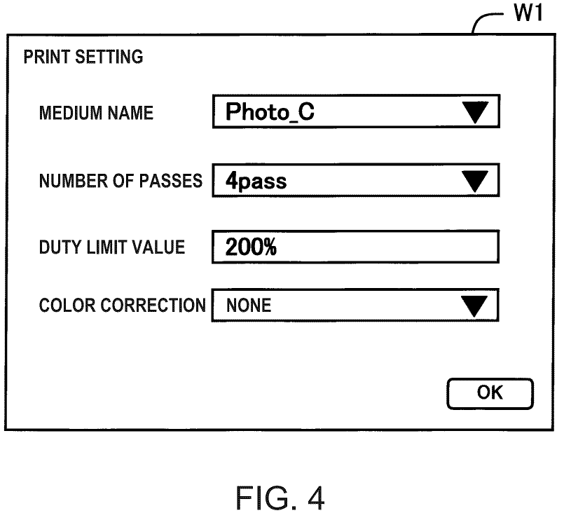

FIG. 3 is a flowchart illustrating a procedure of the creation process of a color prediction model. In step S10, the process setting section 51 receives various process settings related to the creation process of the color prediction model CM. In the first embodiment, the process setting includes (1) a print setting, (2) a colorimetry setting, and (3) selection of color chart data. Hereinafter, these process settings will be sequentially described. FIG. 4 is an explanatory diagram showing an example of the print setting window W1. The user can use this window W1 to set four items related to the printing of the color chart CC, the items are (1) Medium name; (2) Number of passes; (3) Duty limit value; and (4) presence or absence of color correction.

“Number of passes” means the number of main scans of the print head for printing all pixels on one main scan line. For example, “4 passes” means that all pixels on one main scanning line are printed by performing the main scanning four times. As the number of passes, for example, one pass or two passes can be selected.

“Duty limit value” is an upper limit value of the total amount of ink allowed to be ejected to one pixel. In the example of FIG. 4, it is possible to designate the duty limit value to be used for actual printing in consideration of a case where a medium selected in the print setting is different from the medium to be used for actual printing. In this case, the amount of ink ejected to each pixel in actual printing is corrected as follows in consideration of the designated duty limit value.

$$Vc = V \times ( Dt\_set / Dt\_pre ) \qquad ( q1 )$$

Here, Vc is the amount of ink after correction, V is the original amount of ink, Dt_set is the duty limit value designated in the print settings, and Dt_pre is the duty limit value that was set when the color chart data 62 was created. Normally, Dt_set is set to a value equal to or less than Dt_pre. However, Dt_set may be set to a value larger than Dt_pre.

In the “color correction” column, it is possible to designate either no color correction and color correction. The setting of “no color correction” means that, in a case where a process such as a raster image processor (RIP) is used in the printing of the color chart CC, the color management function is set to OFF so that the correction related to the color is not executed.

Note that some of the four items that can be set in the print setting window W1 may be omitted, and other items may be added. The same applies to windows for other process settings described below.

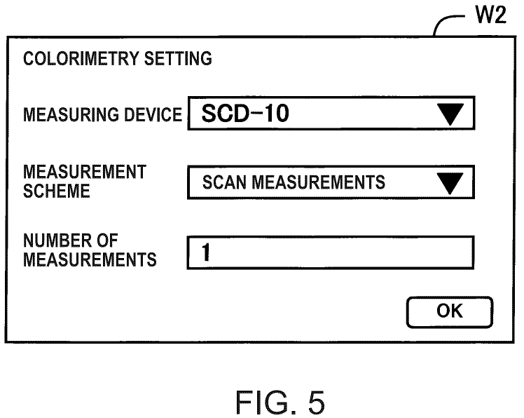

FIG. 5 is an explanatory diagram showing an example of the window W2 for colorimetry setting. The user can set three items using this window W2, as items relating to spectral reflectance measurement of the printed color chart CC, the items are: (1) measurement device; (2) measurement method; and (3) number of measurements.

A “measurement device” is a setting of identification information of the colorimeter 300. As the identification information, a model number or a device name can be used.

As the “measurement method”, a measurement method that can be performed by the colorimeter 300 can be selected. In general, two measurement methods of spot colorimetry and scan colorimetry are known. Spot colorimetry is a method of performing colorimetry by stopping the colorimeter for each color patch. Scan colorimetry is a method of continuously reading a plurality of color patches while moving a measuring device. Scan colorimetry can complete colorimetry of color patches for one page in a considerably shorter work time than can spot colorimetry.

As the “number of measurements”, one time can be set, or an arbitrary number of times of measurement equal to or more than two times can be set. In general, as the number of measurement is increased, variation in the measurement results of the spectral reflectance is suppressed, and thus the prediction accuracy of the color prediction model CM is also improved, but the work time is increased. In general, since the colorimeter itself is a measuring instrument having measurement variation, it is preferable to suppress measurement variation by performing measurement a plurality of times and calculating a statistical value thereof. When the number of times of measurement is set to a plurality of times, in the case of spot colorimetry, the position is moved to the next color after the same color is measured the designated number of times, but in the case of scan colorimetry, the row is scanned the designated number of times. This is also a factor that affects the work time.

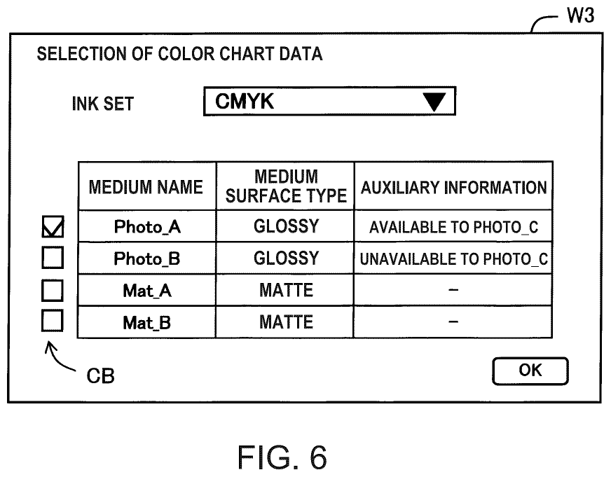

FIG. 6 is an explanatory diagram showing an example of a window W3 for selecting the color chart data 62. In the window W3, when the user selects an ink set, attributes of plural sets of color chart data suitable for the ink set are displayed. In this example, a medium name, a surface type of a medium, and auxiliary information are displayed as attributes of individual sets of color chart data. These attributes are information registered in the color chart information 63 shown in FIG. 2. The window W3 is provided with a check box CB. The user can select one set of color chart data by checking for one check box CB.

In the print setting of FIG. 4 described above, Photo_C is selected as the medium, but the plural sets of color chart data 62 of FIG. 2 do not include the medium of Photo_C. Also in this case, since the auxiliary information indicating that the color chart data can be used for Photo_C is shown in FIGS. 2 and 6, the user can select one color chart data suitable for Photo_C.

When Photo_C is selected as the medium in the print setting of FIG. 4, the window W3 of FIG. 6 may be displayed in a state where the color chart data in which Photo_C can be used is automatically selected. In this way, it is possible to automatically present color chart data candidates suitable for the medium selected in the print setting.

To select the color chart data 62, a list is presented in FIG. 2 may be used instead of the list shown in FIG. 6. These lists are common in that they include the print medium information indicating one print medium among a plurality of print mediums that can be used in the printing device 200 and ink set information indicating one ink set among a plurality of ink sets that can be used in the printing device 200, as setting information suitable for each set of the color chart data 62. By using such a list, it is possible to select data suitable for the combination of the print medium and the ink set as the color chart data 62 used for creating the color prediction models CM.

In the various process settings described with reference to FIGS. 4 to 6, items other than the selection of the color chart data may be appropriately omitted.

When the above-described various settings are performed by the user, the process proceeds to step S20 in FIG. 3, and the data acquisition section 52 acquires the selected color chart data 62 from the storage section 60. As described above, one set of color chart data 62 represents data for N sheets of color charts CC.

Steps S31 to S35 interposed between step S30s and step S30e is a routine whose processes are repeated while increasing the parameter n, which represents the number of sheets of the color chart, by a predetermined increment within a range of 1 to N. The increase width can be set to an arbitrary integer of 1 or more. This routine corresponds to the accuracy calculation process executed by the accuracy calculation section 53. Note that the initial value of the parameter n may be set to a value larger than 1. In the following description, “the number of color charts n” is also simply referred to as “the number of charts n”.

In step S31, the accuracy calculation section 53 obtains the predicted values of the spectral reflectances of the n color charts CC using the simple color prediction model SM. This predicted value is called “predicted spectral reflectance”. Each color chart CC includes a plurality of color patches, and the predicted spectral reflectance is acquired for each of the color patches.

In step S32, the accuracy calculation section 53 creates n tentative training datasets corresponding to the n color charts CC by using the predicted spectral reflectances. One tentative training dataset is a tentative training dataset related to a plurality of color patches included in one color chart CC. One set of tentative training data is data indicating the relationship between the ink amount set and the predicted spectral reflectance for one color patch. The reason why “tentative” is added before “training data” is that the spectral reflectance is not a measured value but a predicted value. In step S33, the accuracy calculation section 53 executes training of a tentative color prediction model PM using n tentative training datasets.

In step S34, the accuracy calculation section 53 calculates the prediction accuracy of the tentative color prediction model PM by using the accuracy check data 64. As the index indicating the prediction accuracy, for example, a mean value of color differences between first L*a*b* values calculated from predicted values of spectral reflectance and second L*a*b* values calculated from actual measurement values of spectral reflectance can be used. The predicted value of the spectral reflectance can be obtained by inputting the ink amount set of the accuracy check data 64 to the trained tentative color prediction model PM. As the measured value of the spectral reflectance, a value included in the accuracy check data 64 can be used. The reason why the “average value of the color difference” can be obtained is that the accuracy check data 64 indicates the relationship between the ink amount set and the measured value of the spectral reflectance for the plurality of color patches, and thus the color difference is calculated for the plurality of color patches. The color difference ΔE as the index representing the prediction accuracy is also referred to as “predicted color difference”. The higher the prediction accuracy, the smaller the predicted color difference.

In step S35, the accuracy calculation section 53 determines whether the prediction accuracy of the tentative color prediction model PM has reached the target accuracy. In a case where the prediction accuracy does not reach the target accuracy, the process returns from step S30e to step S30s, and the accuracy calculation section 53 increases the number n of color charts by one and performs the processes of step S31 and the subsequent steps again. On the other hand, if the prediction accuracy has reached the target accuracy, the process advances to step S36, and the accuracy calculation section 53 determines the current number n of color charts as the optimum number n_{c}.

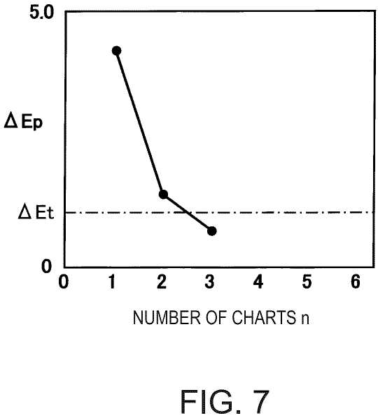

FIG. 7 is an explanatory diagram showing the relationship between the number of color charts and the prediction accuracy in the first embodiment. Here, a prediction color difference ΔEp is used as an index representing prediction accuracy. In the example of FIG. 7, when the number n of color charts is set to 3, the predicted color difference ΔEp is equal to or less than the target color difference ΔEt and the prediction accuracy reaches the target accuracy, so that the optimum number n_{c} is determined to be 3.

As described above, in a case where the prediction accuracy does not reach the target accuracy in step S35, the process returns from step S30e to step S30s, and the accuracy calculation section 53 increases the number n of color charts by one and performs the processes of step S31 and the subsequent steps again. If the prediction accuracy does not reach the target accuracy until the number n of color charts reaches the maximum value N, the process proceeds to step S40. In step S40, the accuracy calculation section 53 determines the optimum number n_{c} of color charts having the best prediction accuracy among the number n of color charts equal to or less than N.

When the optimum number n_{c} is determined in Step S36 or Step S40, the process proceeds to Step S50, and the training data creation section 55 performs printing by the printing device 200 and colorimetry by the colorimeter 300 for the n_{c} sheets of the color chart to create training data including the measurement result of spectral reflectance R(λ). This training data is also referred to as “actual training data”. Each set of the actual training data includes an ink amount set and a measured value of the spectral reflectance R(λ). The measurement of the spectral reflectance R(λ) is executed by the colorimeter 300. The colorimeter 300 may be mounted on the printing device 200.

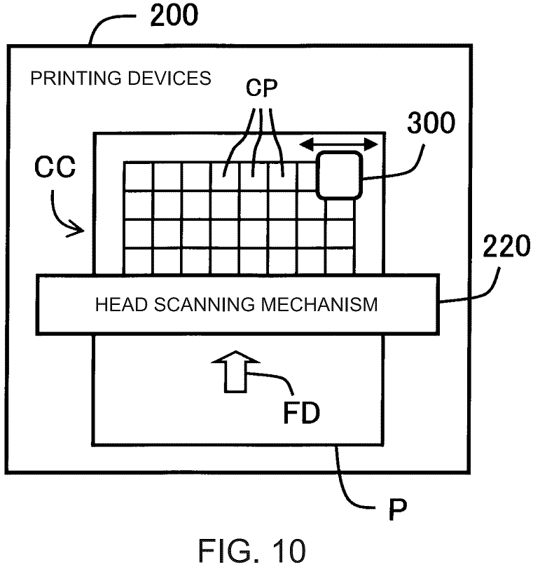

FIG. 10 is an explanatory diagram illustrating an example of the printing device 200 including the colorimeter 300. In this example, the plurality of color patches CP of the color chart CC are printed on the print medium P by a head scanning mechanism 220 of the printing device 200. The colorimeter 300 is disposed downstream of the head scanning mechanism 220 in the feed direction FD of the print medium P. Therefore, immediately after the color patch CP is printed, it is possible to perform the measurement of the spectral reflectance R(λ) using the colorimeter 300 in the printing device 200. In a case where the printing device 200 is configured to couple with a server via a network, the measured spectral reflectance R(λ) may be transmitted to the server, and the color prediction model CM may be automatically created by using a color prediction model creation section provided to the server.

In step S60, the training section 56 executes training of the color prediction model CM using the actual training data. The color prediction model CM can be, for example, a regression model of a multidimensional output configured by a neural network. Such a color prediction model CM becomes an inference model capable of predicting the spectral reflectance from an arbitrary ink amount set of the ink set by executing machine learning using the actual training dataset.

Note that the training of the tentative color prediction model PM in step S33 can also be executed by changing the number of times of training and the training method. Here, the “number of times of training” means the number of epochs, that is, “how many times the same training data is repeatedly used to train”. For the number of times of training, for example, the following method may be applied.
(1) The number of times of training is set to a constant value.
(2) The number of times of training is changed according to the number n of color charts.
(3) The number of times of training is changed according to the prediction accuracy (predicted color difference ΔEp) of the tentative color prediction model PM.

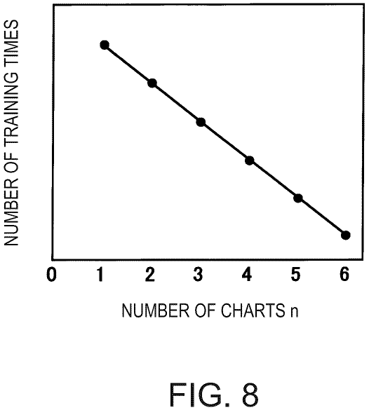

FIG. 8 is an explanatory diagram showing an example in which the number of times of training of the tentative color prediction model PM is changed according to the number of color charts. In this example, as the number n of color charts increases, the number of times of training of the tentative color prediction model PM is decreased. In this way, even if the number n of color charts increases, it is possible to prevent the work time required for training from becoming excessively long.

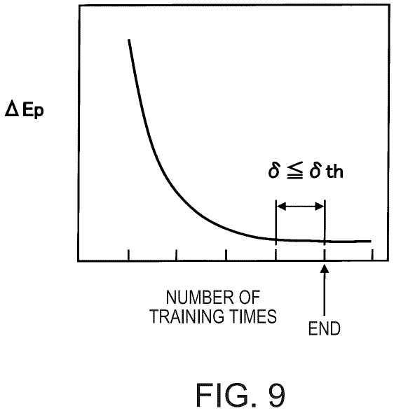

FIG. 9 is an explanatory diagram illustrating an example of changing the number of times of training of the tentative color prediction model PM in accordance with the prediction accuracy. In this example, the training is ended at the time when the decrement width δ of the predicted color difference ΔEp of the tentative color prediction model PM becomes equal to or less than a threshold δth when the number of times of training is increased. In this way, training that does not contribute to an improvement in prediction accuracy can be omitted, so that the total work time can be shortened.

As a training method, a method of additionally training the trained tentative color prediction model PM by using transfer training or fine tuning may be used. For example, training may be executed, by adding one set of tentative training dataset for the (n+1)-th color chart to the tentative color prediction model PM that was trained using n tentative training datasets for the n color charts. In this way, the work time required for training the tentative color prediction model PM can be shortened.

As described above, in the first embodiment, the number n_{c} of color charts with which sufficient prediction accuracy can be obtained can be determined using the simple color prediction model SM. In addition, since the color prediction models CM are created by printing the n_{c} sheets of the color charts and using the measurement results of the spectral reflectances, it is possible to efficiently shorten the work time required for creating the color prediction model CM.

### B. Second Embodiment

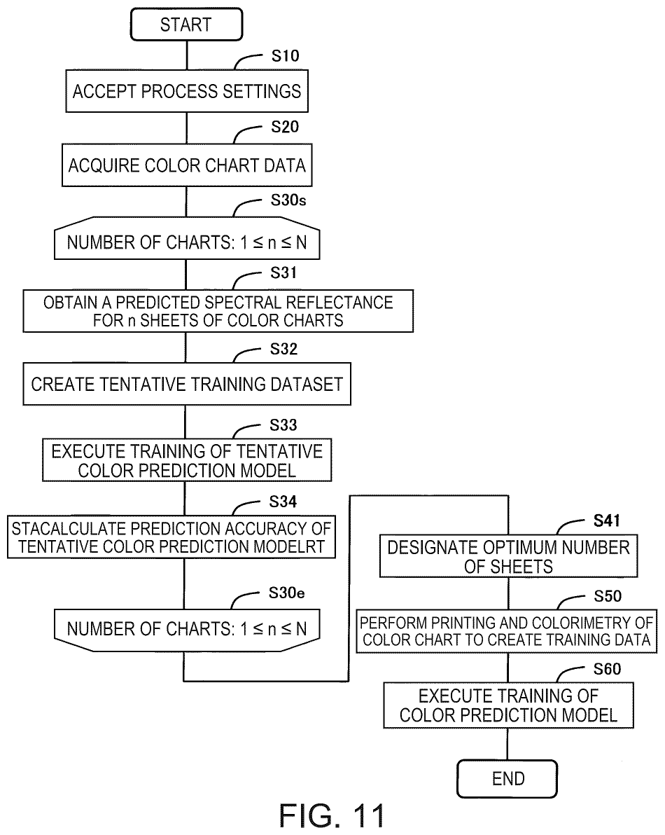

FIG. 11 is a flowchart illustrating a procedure of a color prediction model creation process according to a second embodiment. The apparatus configuration of the second embodiment is the same as that of the first embodiment. The processing of FIG. 11 differs from the processing of the first embodiment shown in FIG. 3 only in the following two points.
(1) Steps S35 and S36 is omitted.
(2) Step S40 is replaced by Step S41.

In the second embodiment, the accuracy calculation process from step S31 to S34 is continuously executed until the number n of color charts reaches N. Thereafter, in step S41, the optimum number n_{c} of color charts is determined. In one example, the accuracy calculation section 53 displays the relationship between the number n of color charts and the prediction accuracy on the display device 400, and receives designation of the optimum number n_{c} by the user.

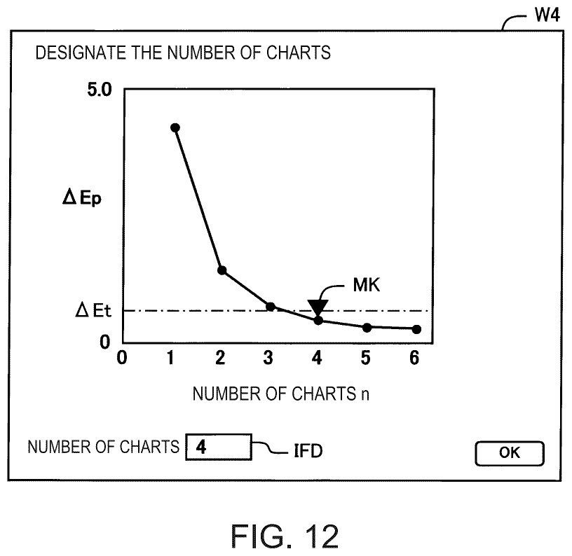

FIG. 12 is an explanatory diagram showing an example of a window W4 for designating the number of color charts in the second embodiment. This window W4 has a graph showing the relationship between the number n of color charts and the predicted color differences ΔEp and an input field IFD for inputting the optimum number n_{c}. The user can designate the optimum number n_{c} that can achieve the target color difference ΔEt by inputting an integer in the input field IFD. The optimum number n_{c} may be designated by using a marker MK in the graph. Further, the indication of the target color difference ΔEt may be omitted.

As described above, in the second embodiment, the accuracy calculation section 53 continuously executes the accuracy calculation process until the number n of color charts reaches N, displays the relationship between the number n of color charts and the prediction accuracy, and receives the designation of the optimum number n_{c} by the user. As a result, the user can determine the number n_{c} of color charts suitable for training of the color prediction model CM in consideration of the balance between the prediction accuracy and the work time. That is, it is possible to reflect the user's intention such as “reduce the number of sheets by giving priority to time” or “increase the number of sheets by giving priority to accuracy”.

In step S41, instead of receiving the designation of the optimum number n_{c} by the user, the accuracy calculation section 53 may determine the number n of color charts having the best prediction accuracy as the optimum number n_{c}. As in the first embodiment, a plurality of color patches divided in units other than one color chart may be used as one color patch group.

### C. Third Embodiment

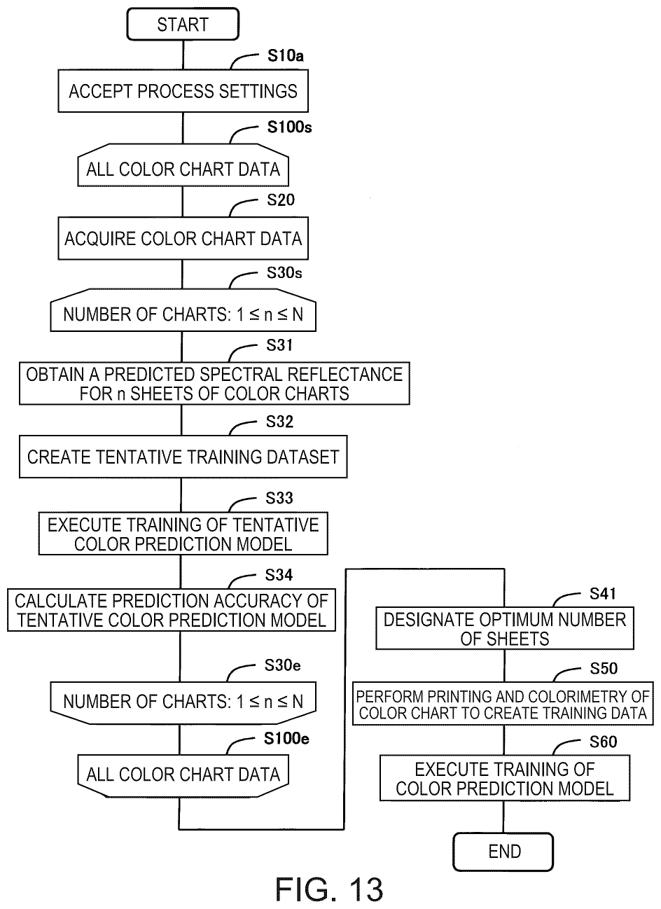

FIG. 13 is a flowchart illustrating a procedure of a color prediction model creation process according to a third embodiment. The apparatus configuration of the third embodiment is the same as those of the first embodiment and the second embodiment. The processes of FIG. 13 are different from the processing of the second embodiment shown in FIG. 11 only in the following two points.
(1) The insertion of the start step S100s, which is a routine that selects the target to be processed one by one from all color chart data, before step S20 for obtaining color chart data, and the insertion of the corresponding end step S100e after step S30e.
(2) In the process setting of step S10a, neither the designation of the medium described in FIG. 4 nor the selection of the color chart data described in FIG. 6 is performed.

In step S41 of the third embodiment, it is preferable that the accuracy calculation section 53 determines the optimal number n of color charts for which the best prediction accuracy is obtained as no for the color chart data 62 with the best prediction accuracy. In this way, in the accuracy calculation process, the designation by the user is not necessary, and the optimum number n_{c} of color charts can be automatically determined.

However, as in the second embodiment, the designation of the optimum number n_{c} by the user may be accepted in step S41. As in the first embodiment, a plurality of color patches divided in units other than one color chart may be used as one color patch group.

As illustrated in FIG. 2, the plural sets of color chart data 62 include data corresponding to different types of medium. As a processing target of the accuracy calculation process in the third embodiment, it is preferable to use all of the plural sets of color chart data 62 prepared in advance regardless of the type of the medium. In this way, it is possible to create the training dataset of the color prediction model CM by using the color chart data 62 with good prediction accuracy among all the color chart data 62.

Note that, the plural sets of color chart data 62 prepared in advance do not always include the color chart data of all mediums. Therefore, when an unknown medium is used, if plural sets of color chart data 62 prepared in advance are set as targets of the accuracy calculation process, there is an advantage that a medium having the closest color and characteristics can be selected from a plurality of mediums suitable for the plural sets of color chart data 62 and the color chart data 62 can be used.

However, in the process setting of step S10a, if the user designates the medium described in FIG. 4, one or more sets of color chart data 62 suitable for the medium may be selected, and the processes of steps S100s to S100e of FIG. 13 may be executed for these sets of color chart data 62. Also in this case, there is an advantage that the designation by the user is unnecessary and the optimum number no of the color charts can be automatically determined.

### Other Forms

The present disclosure is not limited to the above-described embodiments and can be realized in various forms without departing from the spirit thereof. For example, the present disclosure can also be realized by the following aspects. The technical features in the above-described embodiments corresponding to the technical features in each aspect described below can be appropriately replaced or combined in order to solve a part or all of the problems of the present disclosure or in order to achieve a part or all of the effects of the present disclosure. If the technical features are not described as essential in this specification, the technical features can be appropriately omitted.
(1) According to a first aspect of the present disclosure, there is provided a method of creating a color prediction model for predicting a spectral reflectance from an ink amount set of a plurality of types of inks constituting an ink set. The method includes (a) acquiring color chart data representing N color patch groups, N being an integer of 2 or more; (b) executing an accuracy calculation process sequentially while increasing an integer n, which is an integer of one to N, the accuracy calculation process including (i) creating n tentative training datasets corresponding to n color patch groups using a predicted spectral reflectance predicted by a simple color prediction model that is more easily trainable than is the color prediction model, (ii) creating the tentative color prediction model by training the color prediction model with n tentative training datasets, and (iii) calculating a prediction accuracy of the tentative color prediction model; (c) determining a number n_{c} of color patch groups suitable for training the color prediction model using a relationship between the integer n and the prediction accuracy; (d) executing printing by a printing device and measurement of spectral reflectances for the n_{c} color patch groups, and creating training data including measurement results of the spectral reflectances; and (e) performing training of the color prediction model using the training data.

According to this method, the number n_{c} of color patch groups for which sufficient prediction accuracy can be obtained can be determined using the simple color prediction model, and the color prediction model is created using the results of printing and spectral reflectance measurement for the n_{c} color patch groups, so the work time required to create the color prediction model can be efficiently shortened.
(2) In the above-described method, step (b) includes a step of stopping the increase of the integer n when the prediction accuracy reaches a target accuracy or less and step (c) may include a step of determining the integer n when the prediction accuracy reaches a target accuracy or less as the number n_{c} of the color patch groups.

According to this method, it is possible to easily determine the number of color patch groups in which the prediction accuracy reaches the target accuracy or less, and to shorten the work time.
(3) In the above-described method, step (b) is continuously performed until the integer n reaches the integer N and step (c) may include (c1) displaying a relationship between the integer n and the prediction accuracy and (c2) receiving designation of the number n_{c} of the color patch groups by a user.

According to this method, the user can determine the number of color patch groups used for training of the color prediction model in consideration of the balance between the prediction accuracy and the work time.
(4) In the above-described method, step (a) includes a step of selecting, sequentially from plural sets of color chart data created in advance, one set of color chart data to be used for creating the color prediction model, step (b) is executed for each selected set of color chart data, and step (c) may include a step of determining the number n_{c} of the color patch groups for one set of color chart data having the best prediction accuracy among the plural sets of color chart data.

According to this method, it is possible to create a color prediction model by using one set of color chart data having the best prediction accuracy among plural sets of color chart data while balancing the prediction accuracy and the work time.
(5) In the above-described method, one color patch group may be one sheet of color chart printed on one sheet of print medium.

According to this method, the number suitable for creation of a color prediction model can be determined in units of the number of color charts.
(6) In the above-described method, step (a) may include a step of selecting, from plural sets of color chart data created in advance, one set of color chart data to be used for creating the color prediction model.

According to this method, appropriate color chart data to be used for creating a color prediction model can be selected.
(7) In the above-described method, step (a) includes a step of displaying a list indicating the plural sets of color chart data and the list may include, as setting information suitable for each color chart data, print medium information indicating one print medium among a plurality of print mediums usable in the printing device, and ink set information indicating one ink set among a plurality of ink sets usable in the printing device.

According to this method, the color chart data suitable for the combination of the print medium and the ink set can be selected as the color chart data used for creating the color prediction model.
(8) According to a second aspect of the present disclosure, there is provided a color prediction model creation apparatus that creates a color prediction model for predicting spectral reflectance from an ink amount set of a plurality of types of inks constituting an ink set. The color prediction model creation apparatus includes a data acquisition section configured to obtain color chart data representing N color patch groups, N being an integer of 2 or more; calculation section that executes an accuracy an accuracy calculation process sequentially while increasing an integer n, which is an integer of 1 to N, the accuracy calculation process including (i) creating n sets of tentative training datasets corresponding to n groups of color patches using predicted spectral reflectance predicted by a simple color prediction model that is more easily trainable than is the color prediction model, (ii) creating a tentative color prediction model by performing training of the color prediction model using the n tentative training datasets, and (iii) calculating a prediction accuracy of the tentative color prediction model; a determination section configured to determine a number n_{c} of color patch groups suitable for training the color prediction model using a relationship between the integer n and the prediction accuracy; a training data creation section, for the color patch groups of the number n_{c}, that executes printing by a printing device, that measurement of spectral reflectance, and creates training data including a measurement result of the spectral reflectance; and a training section configured to execute training of the color prediction model using the training data.
(9) According to a third aspect of the present disclosure, a printing system is provided. The printing system includes a color prediction model creation apparatus that creates a color prediction model for predicting spectral reflectance using an ink amount set of a plurality of types of inks constituting an ink set and a printing device. The color prediction model creation apparatus includes a data acquisition section configured to obtain color chart data representing N color patch groups, N being an integer of 2 or more; an accuracy calculation section that executes an accuracy calculation process sequentially while increasing an integer n, which is an integer of 1 to N, the accuracy calculation process including (i) creating n sets of tentative training datasets corresponding to n groups of color patches using predicted spectral reflectance predicted by a simple color prediction model that is more easily trainable than is the color prediction model, (ii) creating a tentative color prediction model by performing training of the color prediction model using the n tentative training datasets, and (iii) calculating a prediction accuracy of the tentative color prediction model; a determination section configured to determine a number n_{c} of color patch groups suitable for training the color prediction model using a relationship between the integer n and the prediction accuracy; a training data creation section, for the color patch groups of the number n_{c}, that executes printing by the printing device and that measurement of spectral reflectance, and creates training data including a measurement result of the spectral reflectance, and a training section configured to execute training of the color prediction model using the training data.
(10) According to a fourth aspect of the present disclosure, there is provided a computer program for creating a color prediction model for predicting a spectral reflectance from an ink amount set of a plurality of types of inks constituting an ink set. The computer program is executed (a) a process of acquiring color chart data representing N color patch groups, N being an integer of 2 or more; (b) a process of executing an accuracy calculation process sequentially while increasing an integer n, which is an integer of one to N, the process including (i) creating n tentative training datasets corresponding to n color patch groups using a predicted spectral reflectance predicted by a simple color prediction model that is more easily trainable than is the color prediction model, (ii) creating the tentative color prediction model by training the color prediction model with n tentative training datasets, and (iii) calculating a prediction accuracy of the tentative color prediction model; (c) a process of determining a number n_{c} of color patch groups suitable for training the color prediction model using a relationship between the integer n and the prediction accuracy; (d) a process of executing printing by a printing device and measurement of spectral reflectances for the n_{c} color patch groups, and creating training data including measurement results of the spectral reflectances, and (e) a process of performing training of the color prediction model using the training data.

The present disclosure can also be realized in various forms other than the image processing device, the printing system, and the computer program. For example, it can be realized in the form of an image processing method, a non-transitory storage medium in which a computer program is recorded, or the like.

What is claimed is:

1. A method for creating a color prediction model for predicting a spectral reflectance from an ink amount set of a plurality of types of inks constituting an ink set, the method comprising:
(a) acquiring color chart data representing N color patch groups, N being an integer of 2 or more;
(b) executing an accuracy calculation process sequentially while increasing an integer n, which is an integer of one to N, the accuracy calculation process including (i) creating n tentative training datasets corresponding to n color patch groups using a predicted spectral reflectance predicted by a simple color prediction model that is more easily trainable than is the color prediction model, (ii) creating the tentative color prediction model by training the color prediction model with n tentative training datasets, and (iii) calculating a prediction accuracy of the tentative color prediction model;
(c) determining a number n_{c} of color patch groups suitable for training the color prediction model using a relationship between the integer n and the prediction accuracy;
(d) executing printing by a printing device and measurement of spectral reflectances for the n_{c} color patch groups, and creating training data including measurement results of the spectral reflectances; and
(e) performing training of the color prediction model using the training data.

2. The method according to claim 1, wherein
step (b) includes a step of stopping the increase of the integer n when the prediction accuracy reaches a target accuracy or less and
step (c) includes a step of determining the integer n when the prediction accuracy reaches a target accuracy or less as the number n_{c} of the color patch groups.

3. The method according to claim 1, wherein
step (b) is continuously performed until the integer n reaches the integer N and
step (c) includes
(c1) displaying a relationship between the integer n and the prediction accuracy and
(c2) receiving designation of the number n_{c} of the color patch groups by a user.

4. The method according to claim 1, wherein
step (a) includes a step of selecting, sequentially from plural sets of color chart data created in advance, one set of color chart data to be used for creating the color prediction model,
step (b) is executed for each selected set of color chart data, and
step (c) includes a step of determining the number n_{c} of the color patch groups for one set of color chart data having the best prediction accuracy among the plural sets of color chart data.

5. The method of claim 1, wherein
one color patch group is one sheet of color chart printed on one sheet of print medium.

6. The method of claim 1, wherein
step (a) includes a step of selecting, from plural sets of color chart data created in advance, one set of color chart data to be used for creating the color prediction model.

7. The method of claim 6, wherein
step (a) includes a step of displaying a list indicating the plural sets of color chart data and
the list includes, as setting information suitable for each color chart data, print medium information indicating one print medium among a plurality of print mediums usable in the printing device, and ink set information indicating one ink set among a plurality of ink sets usable in the printing device.

8. A color prediction model creation apparatus for creating a color prediction model for predicting spectral reflectance from an ink amount set of a plurality of types of inks constituting an ink set, the color prediction model creation apparatus comprising:
a data acquisition section configured to obtain color chart data representing N color patch groups, N being an integer of 2 or more;
an accuracy calculation section that executes an accuracy calculation process sequentially while increasing an integer n, which is an integer of 1 to N, the accuracy calculation process including (i) creating n sets of tentative training datasets corresponding to n groups of color patches using predicted spectral reflectance predicted by a simple color prediction model that is more easily trainable than is the color prediction model, (ii) creating a tentative color prediction model by performing training of the color prediction model using the n tentative training datasets, and (iii) calculating a prediction accuracy of the tentative color prediction model;
a determination section configured to determine a number n_{c} of color patch groups suitable for training the color prediction model using a relationship between the integer n and the prediction accuracy;
a training data creation section that, for n_{c} number of color patch groups, executes printing by a printing device, measurement of spectral reflectance, and creates training data including a measurement result of the spectral reflectance; and
a training section configured to execute training of the color prediction model using the training data.

9. A printing system comprising:
a color prediction model creation apparatus that creates a color prediction model for predicting spectral reflectance using an ink amount set of a plurality of types of inks constituting an ink set and
a printing device, wherein
the color prediction model creation apparatus includes
a data acquisition section configured to obtain color chart data representing N color patch groups, N being an integer of 2 or more,
an accuracy calculation section that executes an accuracy calculation process sequentially while increasing an integer n, which is an integer of 1 to N, the accuracy calculation process including (i) creating n sets of tentative training datasets corresponding to n groups of color patches using predicted spectral reflectance predicted by a simple color prediction model that is more easily trainable than is the color prediction model, (ii) creating a tentative color prediction model by performing training of the color prediction model using the n tentative training datasets, and (iii) calculating a prediction accuracy of the tentative color prediction model,
a determination section configured to determine a number n_{c} of color patch groups suitable for training the color prediction model using a relationship between the integer n and the prediction accuracy,
a training data creation section, for the color patch groups of the number n_{c}, that executes printing by the printing device and that measurement of spectral reflectance, and creates training data including a measurement result of the spectral reflectance, and
a training section configured to execute training of the color prediction model using the training data.

10. A non-transitory computer-readable storage medium storing a program, the program being a computer program for creating a color prediction model for predicting a spectral reflectance from an ink amount set of a plurality of types of inks constituting an ink set, and the program causing the computer to perform:
(a) a process of acquiring color chart data representing N color patch groups, N being an integer of 2 or more;
(b) a process of executing an accuracy calculation process sequentially while increasing an integer n, which is an integer of one to N, the process including
(i) creating n tentative training datasets corresponding to n color patch groups using a predicted spectral reflectance predicted by a simple color prediction model that is more easily trainable than is the color prediction model,
(ii) creating the tentative color prediction model by training the color prediction model with n tentative training datasets, and
(iii) calculating a prediction accuracy of the tentative color prediction model;
(c) a process of determining a number n_{c} of color patch groups suitable for training the color prediction model using a relationship between the integer n and the prediction accuracy;
(d) a process of executing printing by a printing device and measurement of spectral reflectances for the n_{c} color patch groups, and creating training data including measurement results of the spectral reflectances, and
(e) a process of performing training of the color prediction model using the training data.
